(19) United States
(12) Patent Application Publication
(10) Pub. No.: US 2003/0093873 A1
(43) Pub. Date: May 22, 2003

(54) Infinitely variable door arrester

(76) Inventor: Jorg Linnenbrink, Wuppertal (DE)

Correspondence Address: Steven L Oberholtzer, Brinks Hofer Gilson & Lione, P O Box 10396, Chicago, IL, 60610, US

(21) Appl. No.: 10/221,536

(22) PCT Filed: Mar. 9, 2001
(86) PCT No.: PCT/EP01/02650

(30) Foreign Application Priority Data
Mar. 10, 2000 (DE) 200 04 524.5

(51) Int. Cl. E05F 5/06

(52) U.S. Cl. 16/85

(57) ABSTRACT

The invention relates to an infinitely variable door arrester (1), especially for vehicle doors, that comprises the following components: a stationarily mountable first retainer (2), a second retainer (4) that is linked with the first retainer (2) so as to be movable with respect to the first retainer and that is linked with a door, mechanical stopping means (6) that block the two retainers (2, 4) within their range of movement in any relative position to each other in both directions of movement, elastic coupling means (14) that facilitate minimal, relative, elastic control movements in any relative position of the retainers (2, 4) blocked by the stopping means (6) by impinging the retainers with a control force, and control means (16) that control the release of the stopping means (6) in the blocked state by an elastic control movement resulting from the control force. The door arrester (1) is configured as a hinged door arrester, the two retainers (2, 4) being rotationally interlinked by a hinge pin (8) about a rotational axis (10).

The present invention relates to an infinitely adjustable door arrester, in particular for vehicle doors, according to the preamble of claim 1, having a first retaining part which can be fastened in a fixed position in the fastening region of the respective door, a second retaining part which is to be connected to the door and is connected to the first retaining part in a manner such that it can move relative to it, and having braking means which act between the two retaining parts in such a manner that the retaining parts can be blocked in any desired relative positions with respect to each other in “an infinitely adjustable manner”. The respective door can therefore be arrested in any desired opening position.

A door arrester of the type defined in the preamble of claim 1 is disclosed by the corresponding publications DE 198 32 502 A1 and DE 298 12 863 U1. These concern a technically very complex and also relatively large-sized design based on the “retaining-band principle”, in which a retaining band or catch band is fastened at one end in an articulated manner to the body work (door strap) and at the other end is guided in a longitudinally movable manner to an arrester housing. The housing is accommodated in the door region. The retaining band interacts with arresting means accommodated within the housing. In the case of this known, infinitely adjustable door arrester, the retaining band is designed as a threaded spindle which is guided through a spindle nut mounted rotatably in the housing. During movements of the door the spindle, which does not itself rotate, is therefore displaced longitudinally, so that the spindle nut is rotated. The braking means act on the spindle nut in the form of a brake band by the brake band being wrapped around the spindle nut and being subjected to a braking force by a brake lever. However, in the braked position small axial movements against elastic cushions are possible. These movements cause the spindle to initiate rotation of a further control nut which acts on the brake lever in order to release the brake band. Although this known door arrester operates in accordance with the favorable principle of “passive arresting, active release”, it comprises for this reason a very large number of movable individual parts which require a large structural space and also result in a great outlay on production.

FR

2 705 389 describes a further door holder for motor vehicles. In this case, two combined braking and locking measures are described. Firstly, braking means are provided through constant friction in such a manner that the door normally remains in each position, but, as a result, a relatively high basic actuating moment is always required (no “free wheeling”). Secondly, the door can be actively blocked, specifically by means of friction or interlocking engagement. This blocking is caused—in the manner of a seatbelt locking system—by rapid door movements. However, when the door is subsequently at rest, this blocking is automatically canceled again. This therefore involves a different principle here of “active arresting, passive release” which is not according to the generic type.

Also, according to DE 41 03 198 A1, the door has to be actively moved back in each case for arresting purposes. Here, too, an automatic (passive) arresting by simply bringing the door to a stop is not therefore achieved.

DE 41 15 997 A1 describes a “winged hinge fitted with a slam preventer”. Clamping bodies, between which rubber intermediate pieces are seated in each case, are arranged in an annular gap formed between a housing of circular cross section and the hinge pin arranged coaxially therein. This is intended to retain the clamping bodies in a blocking position when at rest. If a certain moment occurs, the blocking is intended to be released by it being possible for the clamping bodies to move against the elastic intermediate pieces. After the moment or the relative movement ceases, the clamping bodies are intended to be reset automatically back into their starting position by the spring force stored in the intermediate pieces, which is intended to result in an infinitely adjustable arresting possibility. However, it is further described in the publication that in each case smooth-surfaced flattened portions running tangentially to the axis of the hinge pin are assigned to the clamping bodies, which are uniformly spaced apart in the circumferential direction, said flattened portions forming enlargements of the annular space holding the clamping bodies. These enlargements constitute clearances permitting the clamping bodies to be reset into their neutral starting or ready position. Thus, only by means of these clearances is the effect achieved that it is possible for the clamping bodies to automatically move back into their blocking position just by the door or the wing coming to rest. In reality, this slam preventer does not therefore involve an infinitely adjustable design because the clearances are formed in each case at certain points on the circumference.

A further door holder is disclosed in U.S. Pat. No. 4,332,056. In a [lacuna] together with a guide part which can be pivoted by two hinge parts, a rolling body is arranged in a rolling-body, holder, said rolling body interacting with a frictional surface in the form of a circular arc. The function is evidently controlled in this case by the rolling-body holder having a certain, cam-like configuration, as a result of which the rolling body can be brought into different positions. Since two control surfaces having different slopes are provided here, the effect in the two different directions of movement should be different. In any case, the arresting, and probably also releasing, controlling measure takes place in each case by means of defined door movements, i.e. not by simply bringing the door to a stop and continuing to move it.

Finally, a pivot bearing having a brake is described in FR 2 173 540 and in the parallel AT 317 482. However, this pivot bearing is used for a goods carrier having a preferably transparent covering, in which a panel which can be pivoted upwards about a horizontal axis of the pivot bearing between an in-use position and an open position is provided. In this case, a directional locking mechanism is inserted between the panel and the brake in such a manner that the panel is able to pivot freely upwards. This brake therefore only acts in one direction of movement. This solution is therefore not suitable as an arrester for a motor vehicle door.

Further door arresters which ensure infinitely adjustable arresting are known, but are controlled and actuated for this purpose by means of separate control means.

DE 196 22 110 A1 describes an infinitely adjustable door arrester based on the retaining-band principle, in which the one retaining part is designed as a door-retaining band or retaining rod and the other retaining part is designed as a housing. The retaining rod is guided in a longitudinally movable manner through the housing and is directly acted upon here by braking means in order to block the longitudinal movement and therefore the door. Conical clamping jaws are provided as braking means, said jaws being pressed via a prestressed spring against a stop in the door arrester housing and, as a result, firmly clamping the retaining rod. However, this known design only blocks a door movement in one direction, since opening of the door is prevented by means of self-locking while closing of the door is possible with a certain force. In order to be able to move the door freely with relatively small force, a special release mechanism in the form of a solenoid or a mechanical device is provided in order to cancel the blocking. However, only the electromagnetic design is described in detail. In a disadvantageous manner, the release mechanism has to be activated separately from the actual handling of the door, in particular by actuating an electric contact. Another particularly disadvantageous feature of the electric or electromagnetic design is that the blocking of the door can no longer be released if the electric power supply should fail.

DE 44 35 720 A1 (corresponding to EP 0 705 951 B1) describes an infinitely adjustable motor vehicle door arrester which is likewise actuated by auxiliary force. In this case, a braking or arresting device is actuated by an electric motor via a pivot lever, specifically as a function of criteria, which can be detected by sensors, of the movement situation of the door. This design is complex in terms of controlling measures and is likewise dependent on the electric power supply.

DE 195 37 816 A1 also describes a further, very similar, infinitely adjustable motor vehicle door arrester. Here, too, a braking or arresting device can be engaged and disengaged by a drive driven by an electric motor, which drive, for its part, can be activated in the braking or releasing sense by means of an electronic control unit as a function of the current opening position, the pivoting direction and the pivoting speed of the door at a particular moment and of other essential data for assessing the movement characteristics of the door. Essentially, the same disadvantages as already described above therefore occur.

The present invention is based on the object of providing an infinitely adjustable door arrester of the generic type, which is distinguished by a configuration which is simple in terms of structure and production and controlling measures and is reasonably priced, and by optimum functional capability, in particular even independently of an electric power supply, and, at the same time, also has a particularly compact structural form.

According to the invention, this is achieved in the case of a door arrester of the type described at the beginning by the characterizing features of claim 1.

Accordingly, the door holder is designed very compactly as a hinge-type door holder. It contains, in a particularly compact construction, the three essential components:

1. Mechanical braking means such that the two retaining parts can be clocked in any desired relative positions with respect to each other within their range of movement in both directions of movement, specifically with a relatively high retaining force or with a high retaining moment, in particular in the region of 30 to 60 Nm,

2. elastic coupling means such that in each relative position of the retaining parts blocked by the braking means small, relative, elastic control movements are possible by applying a control force which is smaller than the retaining force, and

3. control means such that in the respectively blocked state the braking means can be activated for release purposes by means of an elastic control movement resulting from the control force.

The invention therefore provides a compact, infinitely adjustable hinge-type door holder which constitutes a combination of a door hinge with an integrated, infinitely adjustable door holder. This is a particular advantage on account of the fitting situation and of the available accommodating space in the vehicle, but also on account of simple and rapid installation. Using at least predominantly, in particular, however, exclusively, mechanical means, the door holder can advantageously be controlled directly solely by door movements or by introducing force/moment via the door in such a manner (automatic or self-control) that it implements the advantageous braking principle of “passive arresting and active release”. For this purpose, in each blocked position small, elastic relative rotational movements are also possible, said movements, in each case as a control movement, actuating the control means in order to release the braking means, with the result that subsequently a virtually unbraked, dynamic door movement is possible with a significantly lower actuating force or lower actuating moment of, in particular, greater than/equal to approximately 0.5 Nm. To this end, the control means are designed in such a manner that after release of the braking means a dynamic door movement (opening or closing) immediately following the control movement keeps the braking means in their release position until, once at rest again (or at an actuating moment, for example, of below 0.5 Nm), the braking means automatically become blocked again, i.e., for example, without special control movements, by means of a force accumulator, in particular by spring force.

Further advantageous design features of the invention are contained in the subclaims.

The invention will be explained in greater detail with reference to a plurality of preferred exemplary embodiments illustrated in the drawing, in which:

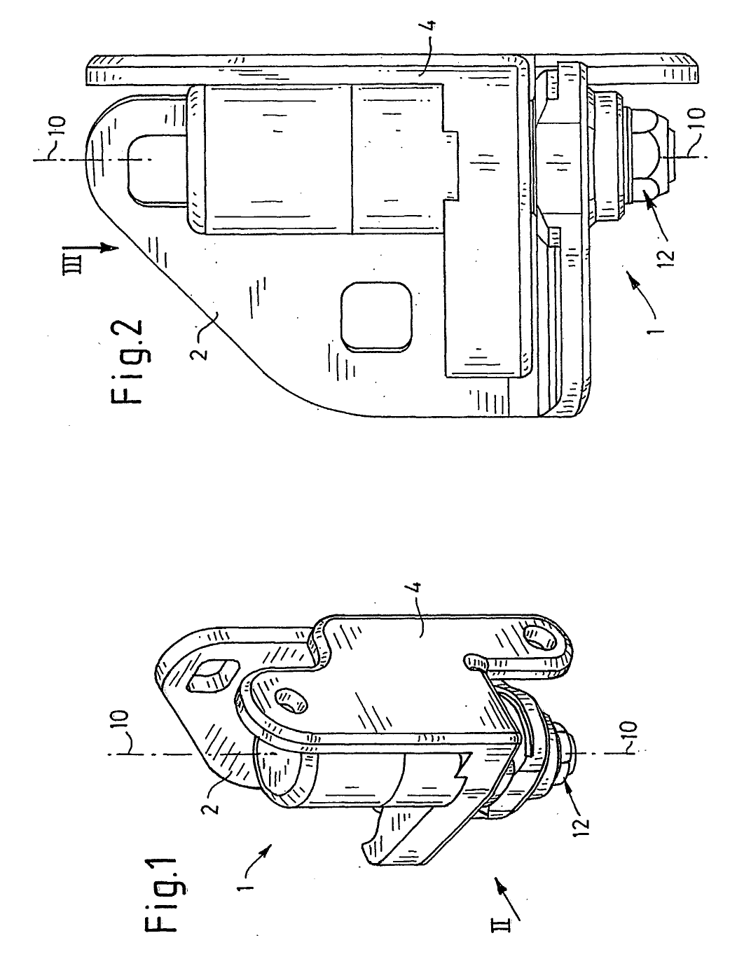

FIG. 1 shows a perspective view of a first embodiment of a door arrester according to the invention,

FIG. 2 shows an enlarged view in the arrow direction II according to FIG. 1,

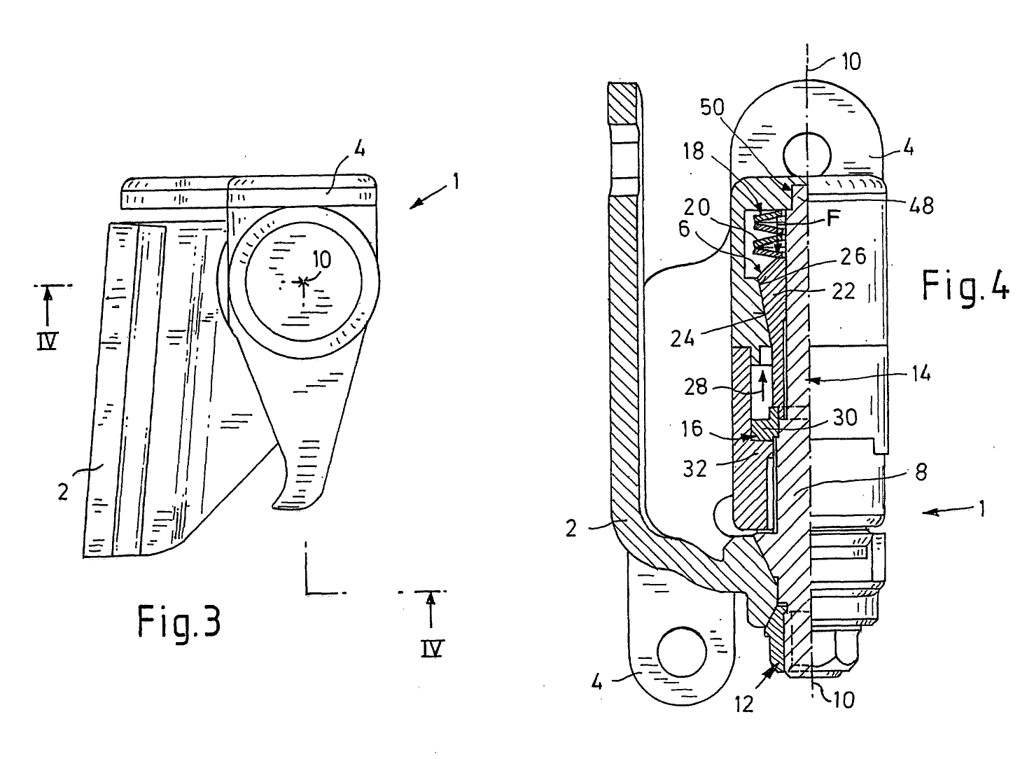

FIG. 3 shows a plan view in the arrow direction III according to FIG. 2,

FIG. 4 shows a partial longitudinal section according to the section line IV-IV in FIG. 3,

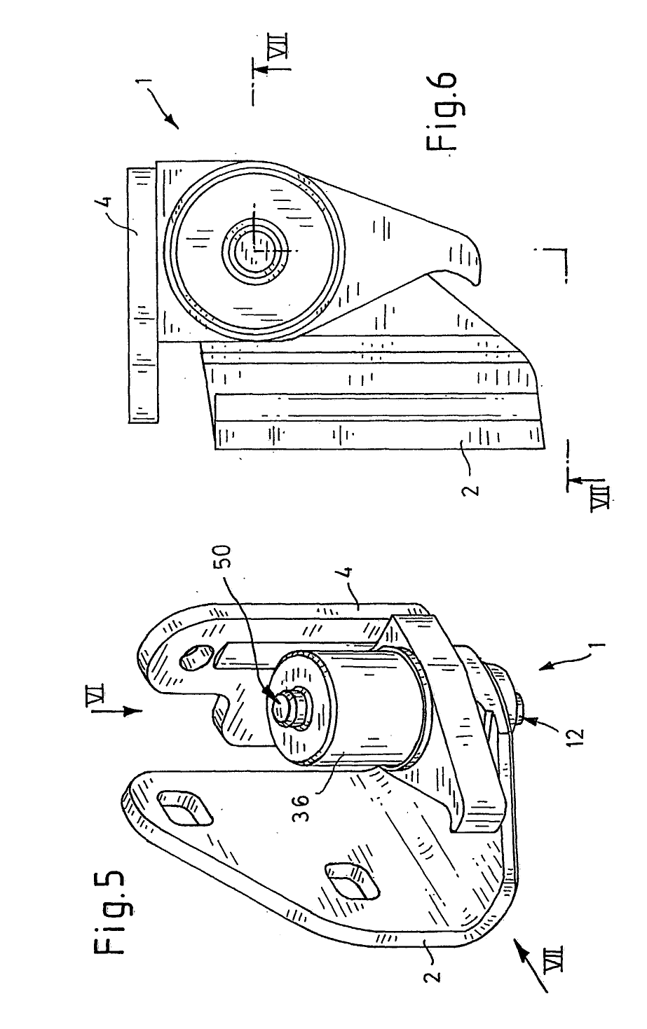

FIG. 5 shows a second embodiment of the door arrester according to the invention in perspective view,

FIG. 6 shows a plan view in the arrow direction VI according to FIG. 5,

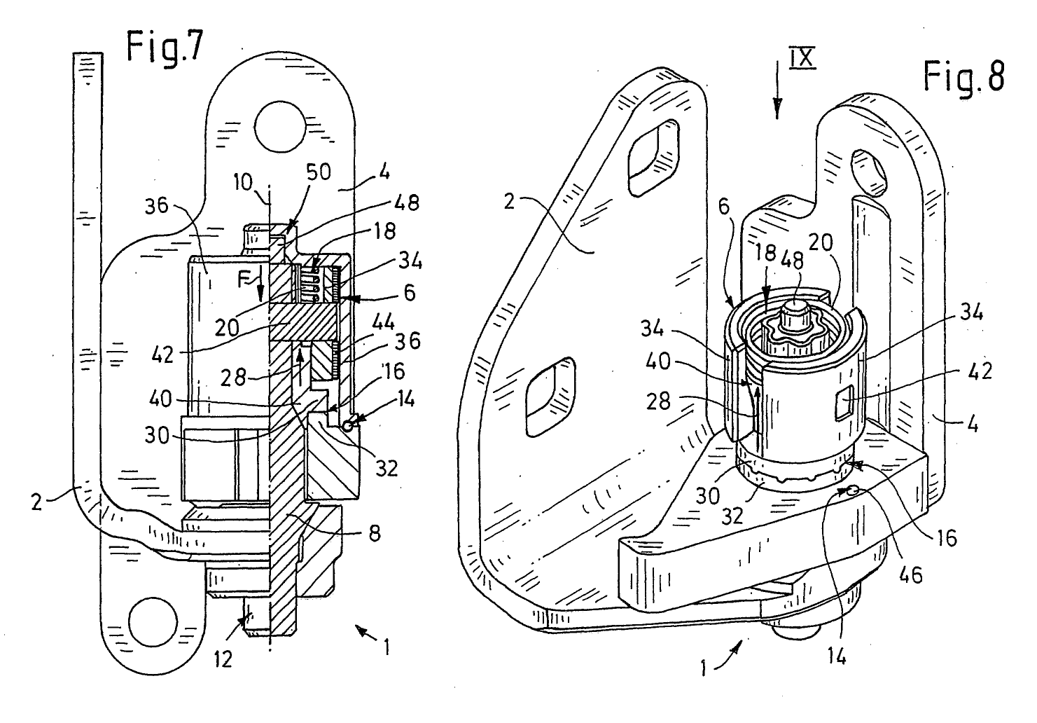

FIG. 7 shows a partial longitudinal section VII-VII according to FIG. 6,

FIG. 8 shows an enlarged perspective view similar to FIG. 5 with the omission of a housing part for a better view of, inter alia, the breaking means,

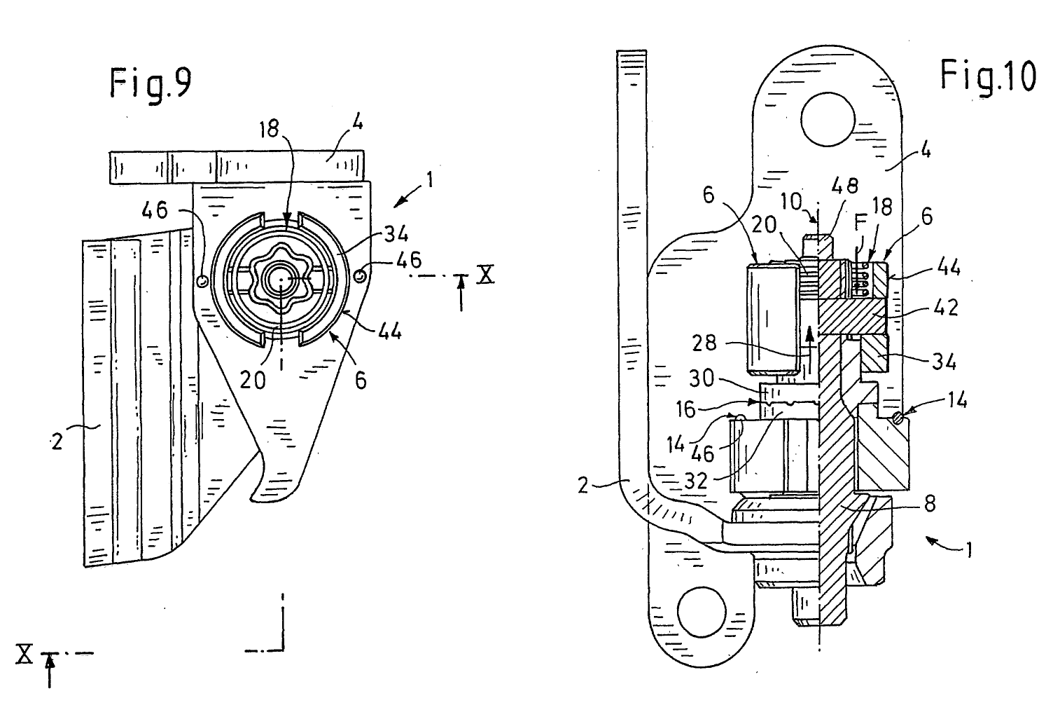

FIG. 9 shows a plan view in the arrow direction IX according to FIG. 8,

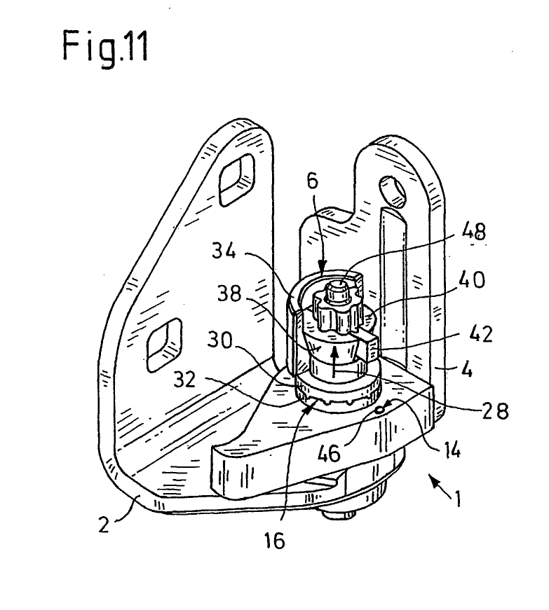

FIG. 10 shows a subsection X-X according to FIG. 9,

FIG. 11 shows a further perspective view similar to FIG. 8 with the omission of a further individual part,

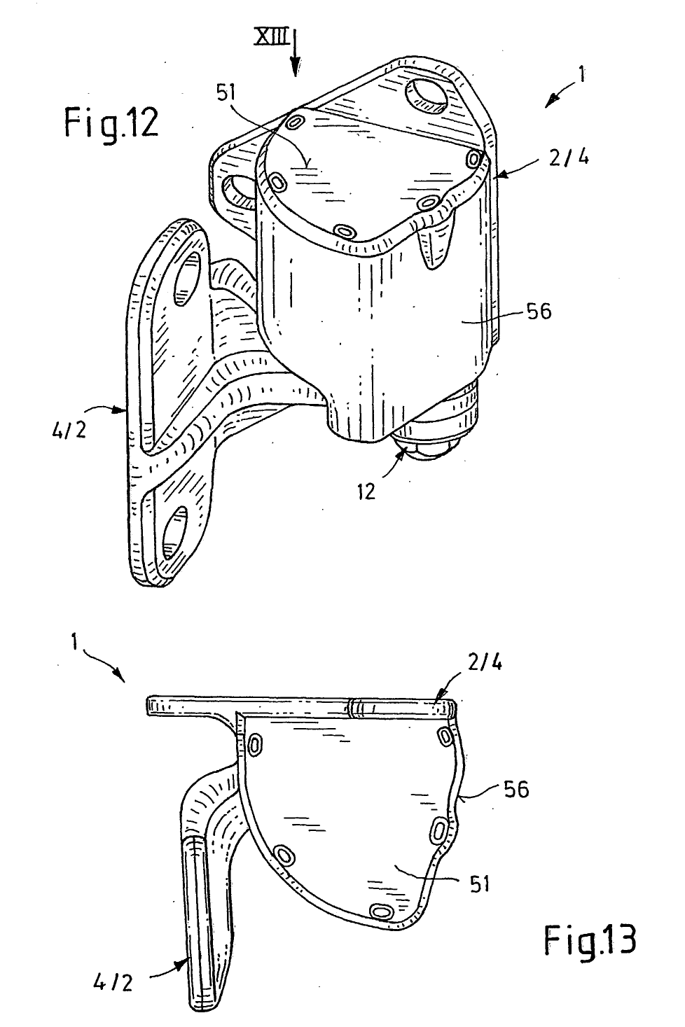

FIG. 12 shows a further, particularly advantageous embodiment of the door arrester according to the invention in perspective view,

FIG. 13 shows a plan view in the arrow direction XIII according to FIG. 12,

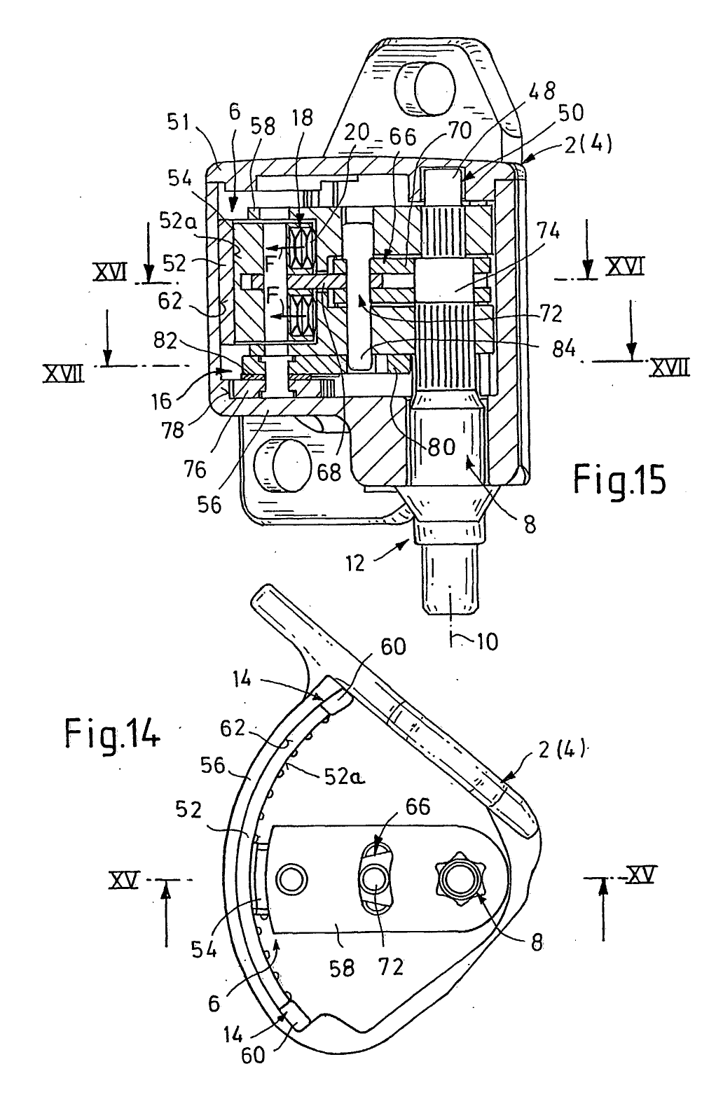

FIG. 14 shows an enlarged view similar to FIG. 13, but with the omission of the one retaining part and of a housing cover, for a view of the inner mechanism,

FIG. 15 shows an axial section in the plane XV-XV according to FIG. 14 (but with cover),

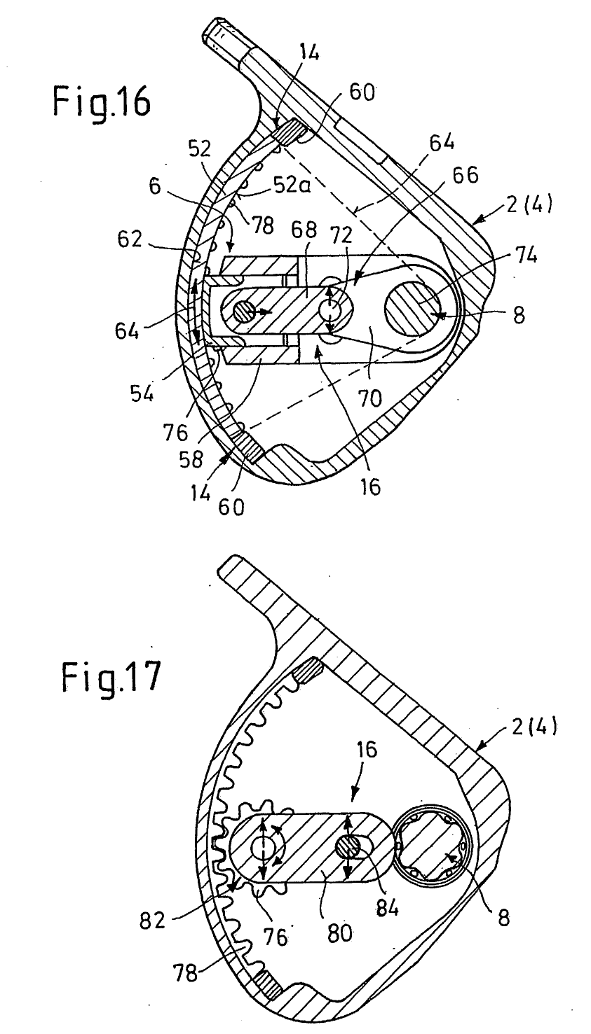

FIG. 16 shows a cross section in the plane XVI-XVI according to FIG. 15, and

FIG. 17 shows a cross section in the plane XVII-XVII according to FIG. 15.

In the various figures of the drawing, identical parts are always provided with the same reference numbers.

In the drawings, a door arrester according to the invention is referred to in its entirely by the reference number 1. This door arrester 1 is suitable in principle for any desired door, in order to arrest the latter in any desired pivoting position. however, the embodiments according to the invention which are illustrated specifically involve a “hinge-type door holder” for vehicle doors, as is described with regard to its basic idea in DE

U 297 13 031 and in the parallel EP

0 893 565 A2. Reference is made at this point to these publications in their entirety. However, the known hinge-type door holder has a latching device which defines only a few specific latching positions as preferential positions of the door.

In contrast thereto, the door arrester 1 according to the invention is of infinitely adjustable design. For this purpose, the door arrester 1 comprises a first retaining part 2 which can be fastened in a fixed position in the fastening region of a door (not illustrated), a second retaining part 4 which is connected to the first retaining part 2 in a manner such that it can move relative to it, and is to be connected to the door, and mechanical braking means 6 in such a manner that the two retaining parts 2, 4 can be blocked in any desired relative position with respect to each other within their range of movement in both directions of movement. The braking means 6 are configured in such a manner that, in the blocked state, they arrest the two retaining parts 2, 4 with a retaining moment preferably of the order of magnitude 30 to 60 Nm. The allocation of the retaining parts 2, 4 to the door and to the vehicle frame (strut) is basically as desired, i.e. the retaining part 2 may also be connected to the door and the retaining part 4 may be connected in a fixed position in the fastening region (frame/strut).

As can best be seen in the sectional views (4, 7, 10 and 15) and in the partial views (FIGS. 8, 9 and 11), in the case of the configuration according to the invention as a hinge-type door holder, the two retaining parts 2, 4 are connected via a hinge pin 8 to each other in a manner such that they can rotate about a rotational axis 10. In this case, the rotational axis 10 coincides with the pivot axis of the door (not illustrated); the door arrester 1 therefore virtually forms the hinge. It is advantageous in this case to design the door arrester 1 in a manner such that it can be unhinged by permanently assigning the hinge pin 8 together with further components which are essential for functioning, inter alia with the braking means 6, to the one retaining part 4 or 2 and connecting it via releasable connecting means 12 to the other retaining part 2 or 4 in a manner locked with respect to torque. For unhinging purposes, after release of the connecting means 12 the hinge pin 8 can therefore be entirely separated from the one retaining part, in which case, however, the hinge pin 8 remains part of the other retaining part without any change.

According to the invention, furthermore, elastic coupling means 14 (rotationally elastic shaft coupling) are provided between the two retaining parts 2, 4 in such a manner that in each relative position of the retaining parts 2, 4 blocked by the mechanical braking means 6 small, relative, elastic control movements are possible by applying a control force. Finally, for a further component essential for functioning, control means 16 are provided in such a manner that in the respectively blocked state the braking means 6 can be activated for release purposes by means of an elastic control movement resulting from the control force. In this case, the control means 16 are additionally configured in such a manner that after release of the braking means 6 a dynamic door opening or closing movement immediately following the control movement keeps the braking means 6 in their release position, which results in an advantageously easy-running door movement with an actuating torque of only, for example, approximately 0.5 Nm. Once at rest again or at a moment which falls below the actuating moment, for example, below 0.5 Nm, the braking means 6 automatically become blocked again on account of a force accumulator 18, in particular by spring force F of at least one brake spring 20. However, other designs are also conceivable as the force accumulator 18, for example, toggle lever devices and the like.

As far as, specifically, the first embodiment according to FIGS. 1 to 4 is concerned—see in particular, FIG. 4—the braking means 6 are designed in the manner of clamping tongs or a clamping chuck with tong-like braking elements 22 acting radially inward. For blocking purposes, the braking elements 22 interact on the outside via conical surfaces 24 with oblique active surfaces 26 on the housing side in such a manner that they are pushed radially inward, in particular directly against the hinge pin 8, by being acted upon axially via the force accumulator 18 or the spring force F. Accordingly, release of the braking means 6 is possible by a release movement of the braking elements 22 directed counter to the spring force F, see the arrow 28 in FIG. 4. In order to produce this release movement, the control means 16 in this design are formed by a slip coupling, which consists of two coupling parts 30, 32, in such a manner that, in the event of a relative movement caused by an elastic control movement, an axial control movement in the arrow direction 28 for release of the braking means 6 is also forced on the one coupling part 30 by the other coupling part 32. Reference is made in this regard, for example, to FIG. 8, according to which the coupling parts 30, 32, which can be rotated with respect to each other, are in engagement via a type of end toothing, with the result that, in the event of a relative rotation, the coupling part 30 is moved away from the coupling part 32 in the arrow direction 28 via the toothing. In this case, the coupling parts 30, 32 are configured in such a manner that, in the event of a dynamic relative rotation, re-engagement is avoided. Rather, the release of the braking means 6 is to be retained until the relative rotation is completely finished. Only then does the reengagement take place in order to block the braking means 6.

Furthermore, in the case of the first design according to FIGS. 1 to 4, the elastic coupling means 14 are formed by a section of the hinge pin 8 which acts as a torsion spring. According to FIG. 4, in the blocked state of the braking means 6, the hinge pin 8 is elastically twisted via the braking elements 22 by means of a control force or by means of a control moment. This movement simultaneously has the consequence of a relative movement between the coupling parts 30, 32, which results in the disengagement and release of the braking means 6.

In the case of the second embodiment according to FIGS. 5 to 11, the braking means 6 are designed in the manner of a drum brake having jaw-like braking elements 34, which act, in particular, radially outward, the braking elements 34 being arranged within a braking-drum-like housing part 36 and interacting with oblique active surfaces 38 of a tappet-like control part 40 for blocking purposes. The control part 40 is subjected to spring force F by the force accumulator 18 or the braking spring 20 in order to block the braking means 6. In the opposite direction, the control part 40 can be actuated by the control means 16 (already described) in order to release the braking means 6. The braking elements 34 are connected to the hinge pin 8 in a manner locked with respect to torque, for example via a transverse pin 42. The braking elements 34 preferably have a suitable brake lining 44.

This design according to FIGS. 5 to 11 additionally illustrates, by way of example, that the elastic coupling means 14 can be formed by elastomeric deformation elements 46 arranged between the retaining parts 2, 4. However, these deformation elements 46 are merely indicated schematically in the drawing; in practice, the size, geometry and/or material of the parts can be designed with appropriate elasticity (elastic deformability) to match the angle of rotation desired for the control movement or the door user feel (haptics).

In all of the preferred designs, it is additionally advantageous if the hinge pin 8, which is connected fixedly to the one retaining part at one end via the connecting means 12, is guided in a fixed manner in the region of its other end 48 in a counterbearing 50 on the housing side against movements transversely to its longitudinal axis relative to the other retaining part and the components connected thereto (see, in particular, FIGS. 4 and 7 and also FIG. 15). The counterbearing 50 may be formed, for example according to FIG. 15, by a bearing holding of a housing cover 51.

In the following, the particularly advantageous embodiment according to FIGS. 12 to 17 will be discussed in greater detail. This concerns a structural form which is rotationally asymmetrical with regard to the rotational axis 10 and, in particular, is in the manner of a sector of a circle in cross section. This structural form is of particular advantage as a hinge-type door holder because, starting from the rotational axis 10 or from the hinge pin 8 of the door hinge, there is frequently only sufficient structural space on one side in the vehicle for accommodating components. The preferred structural form permits optimum use to be made of this structural space present in the vehicle.

In the case of this preferred design according to

FIGS. 12 to 17, the braking means 6 comprise a braking path 52 which is in the shape of a sector of a circle and has a concavely curved braking surface 52a, which is in the shape of an arc of a circle and, with regard to its radius of curvature, is coaxial to the rotational axis 10, and a braking element 54 which acts radially against the braking surface 52a by means of spring force F. The braking path 52 and/or the braking element 54 can have a suitable lining material similar to a customary brake lining, in order thereby to achieve a good braking/arresting action by virtue of appropriately high friction values. The braking path 52 is arranged in a housing 56 which is connected, preferably integrally, to the one retaining part 2 or 4. In addition, a guide part 58, which guides the braking element 54 and is connected in radial extent to the hinge pin 8 in a manner locked with respect to torque, is arranged within this housing 56 in a manner such that it can pivot relative to the braking path 52. In this case, the braking element 54 is guided in a guide holder of the guide part 58 with radial movement play with respect to the rotational axis 10 and is subjected to the spring force F by spring elements 20.

In this design, the elastic coupling means 14, which have already been mentioned above, are advantageously provided in the region of the braking path 52 by the braking path 52 being guided relative to the housing 56 in a manner such that it can make about the rotational axis 10 and being supported against the housing 56 in both directions of movement via elastic elements 60. The braking path 52 is guided displaceably on a housing inner surface 62 and/or in an articulated manner via additional retaining means 64 (only indicated by dashed lines in FIG. 16), in particular on the hinge pin 8. As is indicated in FIG. 16 by a double arrow 64, in the adjacent braking position of the braking element 54 the braking path 52 can still move slightly elastically against the elastic elements 60. This movement is used as a control movement for the release of the braking element 54.

For this purpose, the control means 16 have special actuating means for releasing the braking element 54 counter to the spring force F. These actuating means are, when an initially elastic relative movement between the retaining parts 2, 4 occurs, acted upon by resultantly acting driving means for the purpose of releasing the braking element 54. The actuating means are preferably formed by a toggle lever element 66 which comprises two levers 68 and 70 which are connected via a toggle joint 72 which is, in particular, central and has a joint axis parallel to the hinge rotational axis 10. The toggle lever element 66 lies with its two levers 68, 70 in the braked position stretched between the braking element 54 and an abutment—formed, in particular, by a rotational joint section 74 of the hinge pin 8—with the result that deflection of the toggle joint 72 enables the braking element 54 to be pulled back away from the braking surface 52a into a release position. In this case, the lever 68 is also connected in an articulated manner to the braking element 54, i.e. in a manner such that it can pivot about an axis parallel to the rotational axis 10.

The driving means causing the deflection of the toggle lever element 66 comprise a driving wheel 76 and a driving path 78 which is provided coaxially with respect to the braking path 52 and offset axially in the housing 56. It is preferably a toothed drive, the driving wheel 76 being a toothed wheel and the driving path 78 being designed in the manner of a rack, but curved. The driving wheel 76 is assigned a drag lever 80 in such a manner that the driving wheel 76, when rotated via a coupling 82 (in particular slip coupling), deflects (pivots) the drag lever 80 in such a manner that the drag lever 80 acts with its free, pivoted end, via a coupling element 84, on the toggle joint 72 of the toggle lever element 66.

In the preferred design, the coupling element 84 is formed by a bolt which is parallel to the axis 10 and simultaneously also forms the toggle joint 72. For this purpose, it sits in a tilt-free manner in bearing openings of the levers 68, 70 and is guided in slots of the guide part 58 and also of the drag lever 80. The (slip) coupling 82 is configured in such a manner that even a slight, elastic control movement causes the drag lever 80 to be deflected and thus the braking means to be released. A subsequent, essentially unbraked movement for closing or opening the door then retains the braking element 54 in its released position via the coupling 82, the drag lever 80 and the toggle lever element 66. When at rest, the braked position is automatically reached again by the toggle lever element 66 being brought into its stretched position again by the spring force F (see FIG. 16). The particular advantage of the described arrangement is that a very small control force is sufficient in order, in spite of the fairly large spring force F, to pull the braking element 54 into its release position by deflection of the toggle lever element 66. This is because of the very favorable step-up ratio of the toggle lever element 66. The toggle lever element 66 is advantageously arranged in a plane selected in such a manner that tilting moments are avoided as the braking element 54 is being pulled back. In addition, at least one of the two levers of the toggle lever element 66, specifically, as illustrated, the lever 70 in particular, is designed as a double lever having two parallel, axially spaced-apart lever parts, as a result of which a very tilt-free guidance on the rotational joint section 74 is achieved.

The infinitely adjustable door arrester according to the invention has the advantage that the handling of the door for opening and closing purposes corresponds virtually precisely to a previous door holder with a latching device, specifically also as far as the feel of use, the “haptics”, is concerned. The braking means 6 are torque-controlled exclusively via the door, i.e. as a function of the torque acting upon the door and, as a result, also as a function of the kinetic energy. As a result, it is also possible to actuate the door in a dynamic movement, in particular to close it, by the braking means remaining released by the dynamics or the kinetic energy until the door moves into its closed position. In this case, it is also advantageous to design the braking means 6 in such a manner that in the closed position of the door and, expediently, even shortly before a structurally induced free-wheeling occurs. This can be achieved by a corresponding clearance in the region of the interacting braking surfaces. The door can also be pulled shut by an additional force accumulator (“pulling path”).

The invention is not restricted to the exemplary embodiments which have been illustrated and described specifically, but rather also comprises all designs which act identically within the sense of the invention. Thus, for example, in the case of the preferred design according to FIGS. 12 to 17, the driving wheel 76 may also interact with the driving path 78 as a frictional wheel, with the result that the coupling 82—then acting radially instead of axially—would be formed between the driving (frictional) wheel 76 and the (untoothed) driving path 78, in which case the drag lever 80 would have to be connected to the driving wheel 76 in a manner locked with respect to torque. Furthermore, in the case of the designs according to FIGS. 1 to 11, a more simple, “smooth” slip coupling having an additional actuating element, connected downstream as control means 16, for the braking means 6 may also be provided. Finally, in principle, electric or electromagnetic components could also be used, for example as control means 16 and/or in the region of the force accumulator 18.

1. An infinitely adjustable door arrester (1), in particular for vehicle doors, having the following components:
a first retaining part (2) which can be fastened in a fixed position,
a second retaining part (4) which is connected to the first retaining part (2) in a manner such that it can move relative to it and is to be connected to a door,
mechanical braking means (6) such that the two retaining parts (2, 4) can be blocked in any desired relative position with respect to each other within their range of movement in both directions of movement,
elastic coupling means (14) such that in each relative position of the retaining parts (2, 4) blocked by the braking means (6) small, relative, elastic control movements are possible by applying a control force, and
control means (16) such that in the respectively blocked state the braking means (6) can be activated for release purposes by means of an elastic control movement resulting from the control force,
characterized by a configuration of a hinge-type door holder, the two retaining parts (2, 4) being connected via a hinge pin (8) to each other in a manner such that they can rotate about a rotational axis (10).

2. The door arrester as claimed in claim 1, characterized in that the control means (16) are designed in such a manner that after release of the braking means (6) an immediately following, dynamic door movement keeps the braking means (6) in their release position, and in that, once at rest again, the braking means (6) automatically become blocked again by means of a force accumulator (18), in particular by spring force (F).

3. The door arrester as claimed in claim 1 or 2, characterized by an unhingeable design, the hinge pin (8) together with the braking means (6), the elastic coupling means (14) and the control means (16) being assigned to the one retaining part (2 or 4) and being connected via releasable connecting means (12) to the other retaining part (4 or 2) in a manner locked with respect to torque.

4. The door arrester as claimed in one of claims 1 to 3,
characterized in that the braking means (6) are designed in the manner of clamping tongs or a clamping chuck having tong-like braking elements (22), the braking elements (22), which interact with oblique active surfaces (26) for blocking purposes, preferably acting directly on the hinge pin (8).

5. The door arrester as claimed in one of claims 1 to 3,
characterized in that the braking means (6) are designed in the manner of a drum brake having jaw-like braking elements (34), the braking elements (34) being arranged within a drum-like housing part (36) and interacting with oblique active surfaces (38) of a tappet-like control part (40) for blocking purposes.

6. The door arrester as claimed in one of claims 1 to 5,
characterized in that the elastic coupling means (14) are formed by a section of the hinge pin (8) acting as a torsion spring and/or by elastomeric deformation elements (46) arranged between the retaining parts (2, 4).

7. The door arrester as claimed in one of claims 1 to 6,
characterized in that the control means (16) are formed by a slip coupling, which consists of two coupling parts (30, 32), in such a manner that, in the event of a relative movement caused by an elastic control movement, a control movement for release of the braking means (6) is also forced on the one coupling part (30).

8. The door arrester as claimed in one of claims 1 to 3,
characterized by a structural form which is rotationally asymmetrical with regard to the rotational axis (10) and, in particular, is approximately in the manner of a sector of a circle in cross section.

9. A door arrester as claimed in claim 8,
characterized in that the braking means (6) comprise a braking path (52) which is in the shape of a sector of a circle and has a concavely curved braking surface (52a), which is in the shape of an arc of a circle, and a braking element (54) which acts radially against the braking surface (52a) by means of spring force (F).

10. A door arrester as claimed in claim 9, characterized in that the braking path (52) is arranged in a housing (56) which is connected, preferably integrally, to the one retaining part (2 or 4), a guide part (58), which guides the braking element (54) and is connected in radial extent to the hinge pin (8) in a manner locked with respect to torque, being arranged within the housing (56) in a manner such that it can pivot relative to the braking path (52).

11. The door arrester as claimed in claim 10,
characterized in that the braking element (54) is guided in a guide holder of the guide part (58) with radial movement play and is subjected to the spring force (F) by the spring element (20).

12. The door arrester as claimed in claim 10 or 11,
characterized in that the elastic coupling means (14) are formed in the region of the braking path (52) by the braking path (52) being guided relative to the housing (56) in a manner such that it can move about the rotational axis (10) and being supported against the housing (56) in both directions of movement via elastic elements (60).

13. The door arrester as claimed in one of claims 9 to 12,
characterized in that the control means (16) have actuating means for releasing the braking element (54) counter to the spring force (F), the actuating means being, when an initially elastic relative movement between the retaining parts (2, 4) occurs, acted upon by resultantly acting driving means for the purpose of releasing the braking element (54).

14. The door arrester as claimed in claim 13,
characterized in that the actuating means are formed by a toggle lever element (66), two levers (68, 70), which are connected via a toggle joint (72), being arranged in the braked position stretched between the braking element (54) and an abutment—formed, in particular, by a rotational joint section (74) of the hinge pin (8)—in such a manner that deflection of the toggle joint (72) enables the braking element (54) to be pulled back into a release position.

15. The door arrester as claimed in claim 13 or 14,
characterized in that the driving means comprise a driving wheel (76) and a driving path (78) which is provided coaxially with respect to the braking path (52) and offset axially in the housing (56), the driving wheel (76), when rotated, deflecting, via a coupling (82), in particular a lip coupling, a drag lever (80) the end side of which acts, via a coupling element (84), on the toggle joint (72) of the toggle lever element (66).
